(19) United States
(12) Patent Application Publication
(10) Pub. No.: US 2008/0043189 A1
(43) Pub. Date: Feb. 21, 2008

(54) IPS-MODE LCD DEVICE HAVING AN IMPROVED IMAGE QUALITY

(76) Inventors: Yoichi Sasaki, Kawasaki (JP); Teruaki Suzuki, Kawasaki (JP); Mitsuhiro Sugimoto, Kawasaki (JP); Chikaaki Mizoguchi, Kawasaki (JP); Hiromitsu Tanaka, Kawasaki (JP)

Correspondence Address: HAYES SOLOWAY P.C., 3450 E. SUNRISE DRIVE, SUITE 140, TUCSON, AZ, 85718, US

(21) Appl. No.: 11/781,702

(22) Filed: Jul. 23, 2007

(30) Foreign Application Priority Data
Aug. 18, 2006 (JP) 2006-223195

(51) Int. Cl. G02F 1/1337; G02F 1/13

(52) U.S. Cl. 349/126; 349/187

(57) ABSTRACT

A LCD panel includes a LC layer, an active-matrix substrate including an electrode layer for applying a lateral electric field to the LC layer, and a counter substrate opposing the active-matrix substrate with an intervention of the LC layer 11. The active-matrix substrate includes a first alignment film formed in the surface which touches the LC layer 11 by the rubbing technique is formed, and second alignment film 35 formed in the surface which touches the LC layer 11 by the particle beam glaring technique is formed on the counter substrate 13.

This application is based upon and claims the benefit of priority from Japanese patent application No. 2006-223195, the disclosure of which is incorporated herein in its entirety by reference.

### BACKGROUND

1. Field of the Invention

The present invention relates to a liquid-crystal-display (LCD) device and, more particularly, to a lateral-electric-field LCD device such as an in-plane-switching-mode (IPS-mode) LCD device.

2. Description of the Related Art

A LCD device includes backlight unit and a LCD panel disposed on the front side or light-emitting side of the backlight unit. The LCD panel performs an optical switching for the pixels arranged in a matrix therein, and displays an image on the screen. In addition, the LCD panel can also display a video image by continuously performing the optical switching for each pixel.

In recent years, due to the advantages of the lighter weight and smaller thickness of the LCD devices, use of the LCD devices is widely spreading in the fields of in-vehicle apparatus, such as car-navigation system, a variety of industrial device, medical or broadcasting device etc. Along with the spreading use of the LCD devices, a higher performance is more and more desired for the LCD devices.

As a driving scheme for the LCD device, a TN (Twisted-Nematic) mode has been generally employed, wherein the LCD device generates a vertical electric field between a pair of substrates, i.e., between an active-matrix substrate and a counter substrate. The TN mode, however, causes a deviation in the polarization angle of the incident light due to the alignment of the liquid crystal (LC) molecules rising from the surface of the substrate. The deviation increases with an increase of the viewing angle of the observer with respect to the perpendicular to the screen, whereby the LCD device has a relatively poor image quality at a higher viewing angle.

In view of the above problem in the conventional TN-mode LCD devices, lateral-electric-field-mode (LEF-mode) LCD devices such as IPS-mode (In-Plain-Switching-Mode) or FFS-mode ((Fringe-Field-Switching-Mode) LCD devices are proposed and increasingly used. The LEF-mode LCD device generates a lateral electric field, which is parallel to both the substrates sandwiching therebetween a LC layer and thus rotates the LC molecules in the LC layer parallel to the substrates. The LEF-mode LCD device includes an active-matrix substrate including electrodes for applying lateral electric field to the LC layer, TFT (Thin-Film Transistor) elements formed on the active -matrix substrate for driving the electrodes, and a counter substrate opposing the active-matrix substrate with an intervention of the LC layer.

Both the substrates include thereon an alignment film on the surface of the substrates in contact with the LC layer, the alignment film defining the initial alignment of the LC molecules in the LC layer, i.e., during absence of the electric field. As a consequence, the rotational angle of the LC molecules at each gray-scale level is determined by a balance between the applied voltage and the alignment force by the alignment film. Conventionally, a rubbing technique is generally used for forming the alignment film. The rubbing technique is such that a polymer configuring the surface of the alignment film, such as polyamide, is subjected to rubbing by a particular kind of cloth in a specific direction for orienting the surface of the polymer. In recent years, however, scratches or dust formed on/from the surface of the alignment film by the rubbing treatment is considered not negligible because of the increased demand for a higher image quality of the LCD device.

In order to suppress the degradation caused by the scratches or dust in the image quality of the LCD device, a non-contact alignment technique is highlighted wherein the alignment film is formed without using the rubbing treatment. Patent Publication JP-3229281B discloses a particle beam irradiation technique wherein ions or neutral atoms are irradiated onto the alignment film to cut the π-bond between the atoms of alignment film and recombine the atoms in the irradiation direction of the ions or atoms. In this publication, a PE-CVD (Plasma-Enhanced Chemical Vapor Deposition) technique is used to form amorphous hydrocarbon film referred to as DLC (Diamond Like Carbon) as the alignment film.

In the non-contact alignment technique, however, there is also a problem in that the alignment force of the alignment film formed by the non-contact alignment technique is inferior or smaller as compared to the alignment film formed by the rubbing technique. This is because the alignment force provided by the rubbing technique includes the intermolecular force of the π-bond formed between the macromolecular chains coupling the polymer molecules, and an additional force provided by the surface structure of the alignment film including parallel grooves formed by the rubbing treatment, the latter of which the non-contact alignment technique does not provide. The parallel grooves are longer than the alignment of the macromolecular chains in the molecular level or the macromolecular chains.

On the other hand, Patent Publication JP-2002-244138A describes an alignment film formed by using both the rubbing technique and an optical alignment technique, which is one of the non-contact alignment techniques. In this publication, the alignment film of the active-matrix substrate is formed by the optical alignment technique and the alignment film of the counter substrate is formed by the rubbing technique for compensating the smaller alignment force provided by the optical alignment technique.

In the LEF-mode LCD device, the LC molecules are rotated parallel to the substrate surface due to the lateral electric filed generated in the vicinity of the active-matrix substrate, whereby the rotation of the LC molecules are more affected by the surface of the active-matrix substrate compared to the case of the TN-mode LCD device. Thus, the alignment film of the active-matrix substrate formed by the non-contact alignment technique incurs an afterimage because the LC molecules will find difficulty in returning quickly to the initial alignment due to the smaller alignment force. The afterimage is observed more noticeably after a specific image is displayed for a longer time, and when the LC layer is now applied with a weaker electric field due to display of a lower gray-scale level on a normally-black LC panel, for example.

In view of the recent increase in the demand for a higher image quality of the LCD panel, occurring of the afterimage is a large factor degrading the value of the LCD panel. For example, in the field of the medical instrument, wherein the picture of the X-ray machine is displayed on the LCD panel for allowing diagnosis of a patient, there may occur a misdiagnosis if the afterimage occurs after display of a specific picture for a long time. Moreover, in the use of a monitor for broadcasting or television etc., the afterimage reduces the image quality.

### SUMMARY OF THE INVENTION

In view of the above, it is an object of the present invention to provide a LEF-mode LCD device, which is capable of suppressing the occurrence of an afterimage to improve the image quality of the LCD device.

The present invention provides, in a first aspect thereof, a liquid crystal display (LCD) panel including: a liquid crystal (LC) layer; an active-matrix substrate including an electrode layer for applying a lateral electric field to the LC layer, and a counter substrate opposing the active-matrix substrate with an intervention of the LC layer, the active-matrix substrate including a first alignment film in contact with the LC layer, the first alignment film being formed using a rubbing process, the counter substrate including a second alignment film in contact with the LC layer, the second alignment film being formed using a non-contact alignment process.

The present invention provides, in a second aspect thereof, a liquid crystal display (LCD) panel including: a liquid crystal (LC) layer; an active-matrix substrate including an electrode layer for applying a lateral electric field to the LC layer, and a counter substrate opposing the active-matrix substrate with an intervention of the LC layer, the active-matrix substrate including a first alignment film having a first surface in contact with the LC layer, the first surface including thereon a plurality of grooves extending parallel to one another for aligning the LC layer, the counter substrate including a second alignment film having a second surface in contact with the LC layer, the second surface including thereon no groove.

The present invention provides, in a third aspect thereof, a method for manufacturing a liquid crystal display panel including: a liquid crystal layer; an active-matrix substrate including an electrode layer for applying a lateral electric field to the LC layer, and a counter substrate opposing the active-matrix substrate with an intervention of the LC layer, the method including: forming a first alignment layer on the active-matrix substrate; rubbing the first alignment layer to form a first alignment film; forming a second alignment layer on the counter substrate; and irradiating at least one of a light beam and a particle beam onto the second alignment layer to form a second alignment film.

The above and other objects, features and advantages of the present invention will be more apparent from the following description, referring to the accompanying drawings.

### BRIEF DESCRIPTION OF THE DRAWINGS

FIG. 1 is a sectional view of a LCD panel according to a first embodiment of the present invention.

FIG. 2 is a flowchart showing the procedure of a process for manufacturing the LCD panel of FIG. 1.

FIGS. 3A to 3E are sectional views of the active-matrix substrate in the LCD panel of FIG. 1, showing the consecutive steps of a fabrication process thereof.

FIG. 4A to 4F are sectional views of the counter substrate in the LCD panel of FIG. 1, showing the consecutive steps of a fabrication process thereof.

FIG. 5 is a sectional view of a LCD panel according to a second embodiment of the present invention.

FIG. 6 is a flowchart showing the procedure of a process for manufacturing the LCD panel of FIG. 5.

### PREFERRED EMBODIMENT OF THE INVENTION

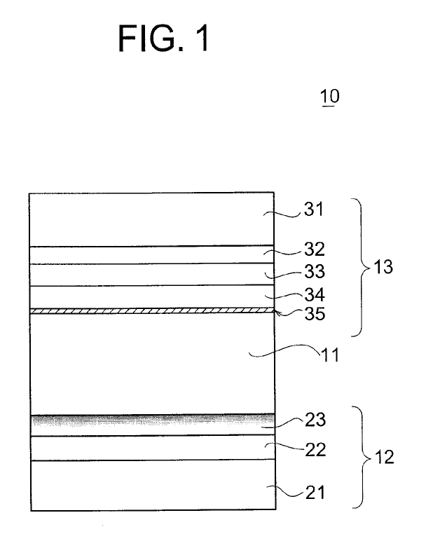

Now, exemplary embodiments of the present invention will be described with reference to accompanying drawings, wherein similar constituent elements are designated by similar reference numerals throughout the drawings. FIG. 1 shows a LCD panel according to a first embodiment of the present invention. The LCD panel, generally designated by numeral 10, is of a LEF-mode, and includes a LC layer 11 including therein LC molecules, an active-matrix substrate 12 mounting thereon drive electrodes or electrode film for applying a lateral electric field to the LC layer 11, and a counter substrate 13 opposing the active-matrix substrate 12 with an intervention of the LC layer 11.

The active-matrix substrate 12 includes a glass substrate 21, on which a functional layer structure 22 and a first alignment film 23 are consecutively formed. The functional layer structure 22 includes a semiconductor layer, a plurality of conductive layers and a plurality of insulation layers, and configures functional elements such as TFTs, drive electrodes including pixel electrodes and common electrodes, and interconnections. The drive electrodes generate a lateral electric field parallel to the surface of the active-matrix substrate 12 and apply the same to the LC layer 11. The first alignment film 23 includes organic resin having a surface subjected to an alignment treatment using the rubbing technique. The organic resin may be polyimide or polyamic acid, for example.

The counter substrate 13 includes a glass substrate 31, on which a black matrix layer (not shown), color layers 32, overcoat 33, and an alignment layer 34 are consecutively formed. The LCD panel 10 is a full-color LCD panel, and the color layers 32 include red, green and blue color layers. Adjacent color layers are overlapped with one another at the boundary therebetween, on which a stripe of the black matrix layer is formed to shield the boundary.

The overcoat 33 has a function of suppressing the pigment or dye in the color layers or black matrix layer and water in the overcoat 33 or underlying layers from diffusing toward the LC layer 11. The overcoat 33 also has a function of reducing the irregularities incurred by the underlying layers. Between the overcoat 33 and the alignment layer 34, there are provided columnar spacers (not shown) for defining the gap between both the substrates 12 and 13. The top surface of the alignment layer 34 has thereon significant irregularities reflecting the underlying columnar spacers, overlapping of the color layers, structure of the black matrix layer etc.

The alignment layer 34 includes a polymer and is formed by a wet-type filming technique such as a flexo printing technique, for example, and is made of polyimide in this example. The surface portion of the alignment layer 34 is subjected to an alignment treatment using a particle beam irradiation technique, to configure a second alignment film 35 thereon. The second alignment film 35 has a chemical structure different from the chemical structure of the body of the alignment layer 34, which is not subjected to the alignment treatment. If the alignment layer 34 is made of a polymer, the alignment layer 34 includes a single or multiple aromatic diamine polycondensation product and cyclization product or products thereof, and has a repetition structure wherein the constituent monomers are included at a composition ratio corresponding to the reactivity ratio and steric structure of the monomers, similarly to the single or multiple aromatic tetracarbon anhydride. On the other hand, in the second alignment film 35, number of carbonyl bonds and conjugate double bonds is reduced compared to the alignment layer 34. The display mode of the LCD panel is a normally-black mode. Other polymer films, such as polyamic acid, may also be used for the alignment layer 34.

According to the LCD panel 10 of the present embodiment, since the first alignment film 23 of the active-matrix substrate 12, which is subjected to a strong electric field, is formed by using the rubbing technique, the first alignment film 23 has a strong alignment force, whereby the LC molecules in the LC layer can be quickly returned to the initial alignment upon elimination of the electric field, to thereby suppress the afterimage. Moreover, since the second alignment film 35 of the counter substrate, which generally have larger irregularities due to the presence of color layers and black matrix layer, is formed by using the non-contact alignment technique, such as the particle beam irradiation technique, occurring of the scratches or rubbing dust can be suppressed, and occurring of the non-oriented region is also prevented to improve the image quality.

More specifically, the LCD panel 10 of the present embodiment improves the image quality by suppressing the afterimage encountered in the conventional LCD panel, in which both alignment films are formed by a rubbing technique. The LCD panel of the present embodiment is especially suited to medical or broadcast equipment and to a television set.

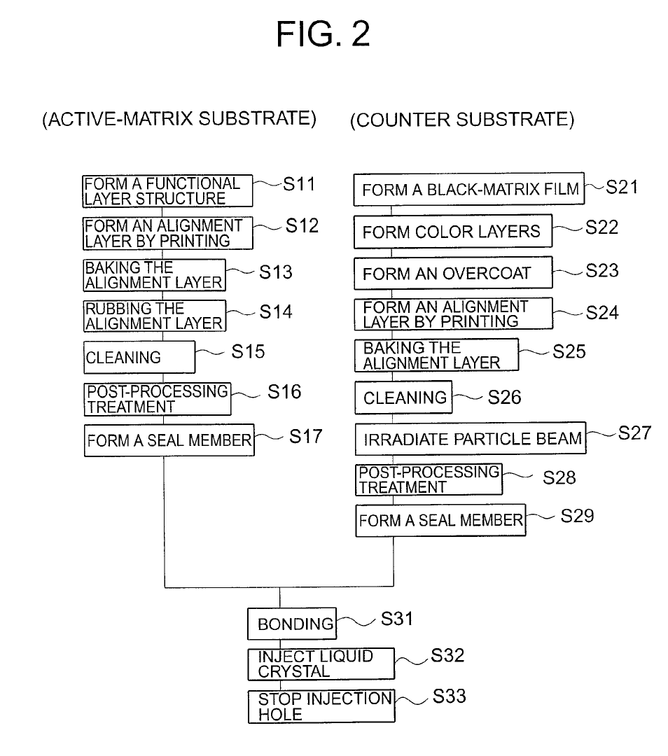

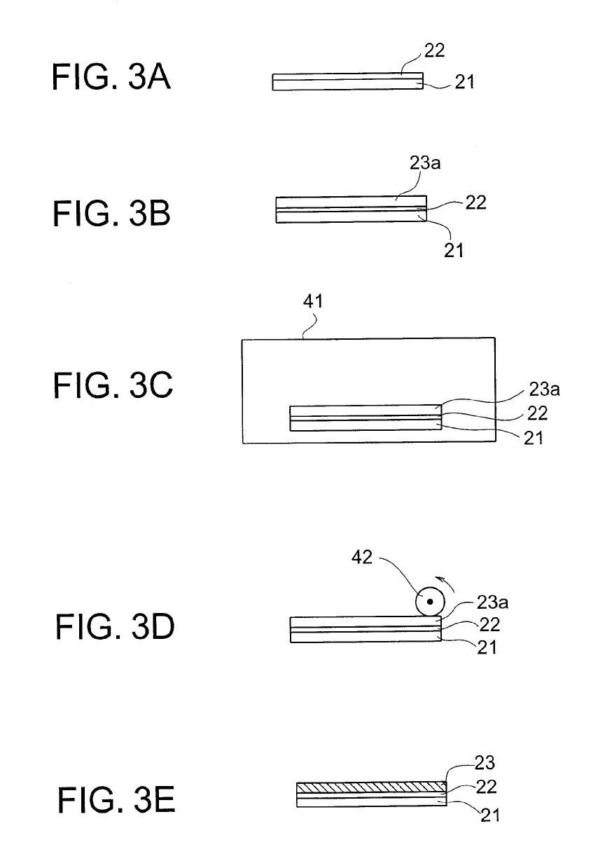

FIG. 2 is a flowchart showing the procedure of a process for manufacturing the LCD panel of FIG. 1. FIGS. 3A to 3E are sectional views of the LCD panel in consecutive steps of the process of FIG. 2. As shown in FIG. 3A, the functional layer structure 22 including semiconductor layer, electrode layer, interconnection layer is formed on the glass substrate 21 (Step S11), followed by forming a polyimide film 23a on the functional layer structure 22 by using an offset-printing technique, as shown in FIG. 3B (Step S12).

Subsequently, the solvent in the polyimide film 23a is removed by heating the active-matrix substrate 12 on a hot plate, as shown in FIG. 3C, followed by introducing the active-matrix substrate 12 into the baking furnace 41. Baking of the polyimide film 23a in a nitrogen atmosphere hardens the polyimide film 23a by a chemical reaction (Step S13). Although the optimum substrate temperature depends on the material of the alignment film, the substrate temperature is preferably between 200 degrees C and 250 degrees C, and may be 230 degrees C, for example, in the present embodiment. After the baking, the active-matrix substrate 12 is cooled. The baking step may be such that the surface of the polyimide film 23a is irradiated with infrared ray. Each process of the solvent removal, baking and cooling may include a plurality of steps.

Subsequently, as shown in FIG. 3D, the surface portion of the polyimide film 23a is subjected to an alignment treatment using a rubbing roller 42, to thereby form the first alignment film 23, as shown in FIG. 3E (Step S14). Thereafter, the surface of the first alignment film 23 is cleaned, if desired (Step S15). The cleaning process may be washing using an ultrasonic wave or using an organic solvent, such as isopropyl alcohol. After the cleaning process, the first alignment film 23 is subjected to a drying process as by using an air knife, high-speed spin of the substrate or a hot-air-drying furnace.

Subsequently, the surface of the alignment film 23 is subjected to a post-processing treatment (Step S16), and the resultant active-matrix substrate 12 is provided with a seal member or adhesive at the periphery thereof. (Step S17).

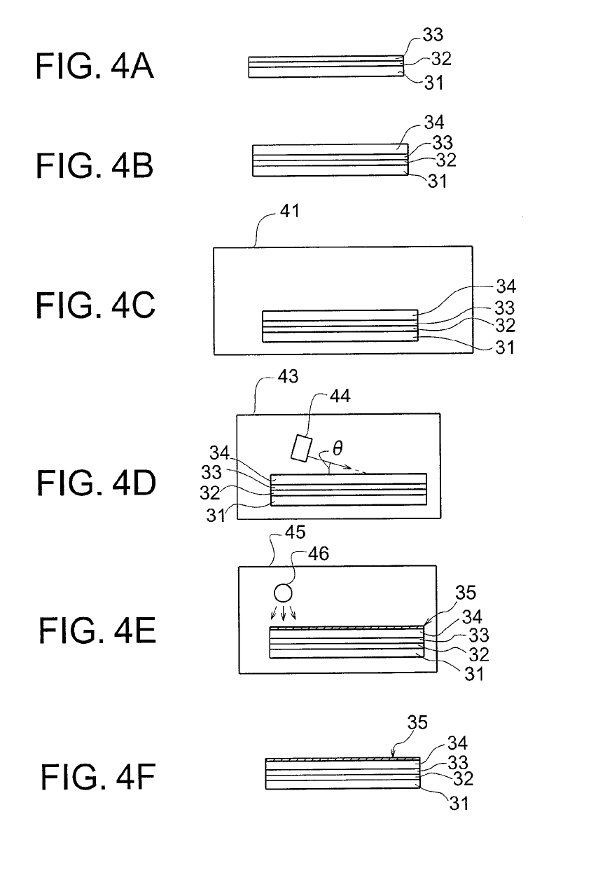

FIGS. 4A to 4F are sectional views of the counter substrate 13 in consecutive steps of the process shown in FIG. 2. The black matrix layer 32 is first formed on the glass substrate 31 (Step S21 in FIG. 2), followed by forming the color layers (not shown) on the black matrix layer (Step S22). The overcoat 33 is then formed on the color layers (Step S23), followed by forming columnar spacers (not shown) on the overcoat 33.

Subsequently, as shown in FIG. 4B, a polyimide film configuring the alignment layer 34 is formed on the overcoat 33 by using a flexo printing technique (Step S24). The alignment layer 34 may be formed using a wet-type filming technique such as a spin-coat or ink-jet printing technique instead. The alignment layer 34 covers the columnar spacers.

As in the case of the active-matrix substrate 12, the counter substrate 13 is heated on a hot plate to remove the solvent from the alignment layer 34, followed by introducing the resultant counter substrate 13 in the baking furnace 41. The alignment layer 34 is then subjected to a baking treatment in a nitrogen atmosphere to harden the alignment layer 34 by a chemical reaction (Step S25). The baking temperature is similar to the case of the active-matrix substrate 12. Each process of the solvent removal, baking and cooling may include a plurality of steps.

After cooling the counter substrate 13, cleaning of the surface of the alignment layer 34 is performed (Step S26). Subsequently, the counter substrate 13 is introduced in an irradiation chamber 43 used for particle beam irradiation, followed by reducing the internal pressure of the irradiation chamber 43 down to roughly a vacuum pressure. A particle beam irradiation process is then performed to the surface of the alignment layer 34, whereby the alignment layer 34 is subjected to an alignment treatment (Step S27). The particle beam irradiation uses an ion beam gun 44, which emits an Ar ion beam towards the surface of the alignment layer 34, as shown in FIG. 4D. During the emission, the ion beam is irradiated in a direction inclined by a specific angle with respect to the substrate face. The incident angle (θ) with respect to the substrate surface is 15 degrees, for example.

A neutralization unit (not shown) is juxtaposed with the ion beam gun 44, the neutralization unit irradiating an electron beam, which neutralizes some of Ar ions in the ion beam irradiated by the ion beam gun 44, to thereby generate Ar atoms among Ar ions. Thus, the surface of the oriental layer 34 is irradiated with Ar ions and Ar atoms, all of which contribute to the alignment treatment. By reducing the ratio of Ar ions with respect to all the particles irradiated onto the alignment layer 34, electrification of the counter substrate 13 can be suppressed, whereby a stable particle beam irradiation is performed onto the surface of the alignment layer 34. The conditions of the ion beam irradiation, such as the internal pressure of the chamber and acceleration voltage for the ions, may be such that described in Patent Publication No. JP-2004-205586, the disclosure of which is incorporated herein by reference.

The particle beam irradiation onto the substrate surface cuts the bonds between macromolecular chains of the surface of the alignment layer 34 and recombine the cut chains, whereby the second alignment film 35 thus formed on the alignment layer 34 includes bonds having an anisotropy in a specific direction. More specifically, the resultant second alignment film 35 has a chemical structure different from the original alignment layer 34. The particle beam irradiation is effected in the direction so as to achieve an anti-parallel alignment in the resultant LCD panel 10.

The particle beam irradiation may use atoms, molecules or ions other than Ar atoms or ions. The particle beam irradiation may be replaced by another non-contact alignment technique. An optical alignment technique may be used by selecting a suitable material for the alignment film and a suitable irradiation technique depending on the application or usage of the LCD panel. The alignment treatment for the second alignment film may be repeated for a plurality of times while using a single technique or different techniques.

The second alignment film 35 may be a splay alignment. Since the splay alignment has a lower asymmetry of the luminance with respect to the viewing angle, combination of the splay alignment with the optical compensation film will suppress the viewing angle dependency of the luminance and coloring. On the other hand, in the anti-parallel alignment, the luminance as observed in a specific direction upon display of a dark state can be reduced. Accordingly, different alignment techniques may be used depending on the usage of the LCD unit.

Subsequent to the particle beam irradiation, the counter substrate 13 is transferred to the post-processing chamber while maintaining the counter substrate 13 under a vacuum pressure. A post-processing treatment is conducted therein by using a filament to heat the substrate surface, and by irradiating specific gas onto the substrate surface (Step S28), as shown in FIG. 4E. Immediately after the particle beam irradiation, the second alignment film 35 includes a number of unstable chemical bonds therein. Therefore, the process employs the gas irradiation onto the substrate surface, thereby terminating the unstable bonds to stabilize the chemical structure thereof.

A mixture of hydrogen and nitrogen is used as the irradiation gas. Patent Publication JP-2004-530790A describes an example of the termination process using the mixture of hydrogen and nitrogen, and the disclosure thereof is incorporated herein by reference. Another gas or another mixture of gas may be used for the termination process instead of the mixture of hydrogen and nitrogen, and in addition, water or an organic substance may be sprayed thereon. The organic substance, if used, may preferably include a suitable polar radical for reducing the pretilt angle of the LC molecules.

After the post-processing treatment, as shown in FIG. 4F, the counter substrate 13 is returned to the atmosphere of the clean room, wherein the seal member is provided on the counter substrate 13 on the periphery thereof (Step S29). The seal member may be formed either one of the active-matrix substrate 12 and counter substrate 13 instead.

Subsequently, the active-matrix substrate 12 and counter substrate 13 are bonded together using the seal member (Step S31). LC is injected into the gap between the active-matrix substrate 12 and counter substrate 13 through an injection hole (Step S32), which is stopped thereafter (Step S33). The injection process may be replaced by a one-drop-fill process wherein one of the active-matrix substrate 12 and counter substrate 13 having thereon a droplet of LC is bonded onto the other by using the seal member, which is subjected to hardening thereafter.

Subsequently, a heat treatment is performed at a temperature higher than the nematic-isotropic transition temperature for the LC, followed by attaching a polarizing film onto the surface of each of the active-matrix substrate 12 and counter substrate 13 far from the LC layer 11. Thereafter, the active-matrix substrate 12 is attached with and connected to tape carrier packages for driving the active elements, i.e., TFTs, thereby completing the LCD panel 10. The LCD panel 10 is combined with a backlight unit to configure a LCD device.

In the process for manufacturing a LCD panel according to the present embodiment, a wet-type filming technique, such as an offset printing technique, may also be used for forming the alignment layer 34, which is made of a polymer. The wet-type filming technique may provide an alignment layer, which is superior in the uniformity of the surface compared to the alignment layer formed by a dry printing technique such as the offset printing technique. This allows easy alignment of the LC molecules, thereby suppressing occurrence of the afterimage. In addition, the process can be simplified and the cost for the LCD panel may also be reduced in respect of the structure, maintenance and process conditions, etc.

It is to be noted that the dry-type filming technique for the alignment layer incurs a hydrophobic alignment film after the particle irradiation process. An excessively hydrophobic property of the alignment film provides a larger driving force for driving the LC molecules away from the alignment film, thereby increasing the pretilt angle of the LC molecules. In addition, the particle irradiation process increases the roughness of the alignment film, which further increases the pretilt angle.

In a typical LEF-mode LCD panel, a larger pretilt angle degrades the viewing-angle characteristic and causes the LC molecules to receive the longitudinal electric field generated in the LC layer, thereby causing leakage of light and afterimage. On the other hand, in the LCD panel manufactured by the process of the present embodiment, the alignment film 34 formed by the wet-type filming process is less hydrophobic and thereby reduces the pretilt angle of the LC molecules. Thus, the present embodiment suppresses the degradation in the viewing angle characteristic, and reduces the leakage light and afterimage of the LCD panel.

An optical irradiation process may be employed for forming the second alignment film 35 of the counter substrate 13, as described in Patent Publication JP-2002-244138A. However, it should be noted that photoreactive resists are generally used in the LCD device as the mask material for the etching process, color layers, black matrix layer and spacers. These photoreactive resists are difficult to be stabilized completely in the chemical characteristics thereof, although a stabilizing treatment is performed onto the photoreactive resists after forming the same as by a heat treatment. Accordingly, if an excessively strong light is irradiated onto these resists during the optical alignment process, these resists may be denatured due to the photoreaction, whereby the resists may be changed in the optical and/or electric characteristics thereof.

In addition, since the alignment film is made of a photosensitive material, an external ray irradiated during use of the LCD panel may degrade the alignment film. Further, since the alignment film formed by the optical irradiation technique has an unstable characteristic, which is significantly changed by the intensity of an optical irradiation, the optical irradiation used in the optical alignment process may cause a significant range of variation in the alignment and pretilt angle of the LC molecules due to the ununiformity of the optical irradiation. Thus, it is preferable to use a proper optical intensity during the optical alignment and to select a suitable material for the alignment film as well as other layers.

In the present embodiment, the alignment layer 34 may be formed on the color layers without forming the overcoat 33. In this case, columnar spacers may be formed, if desired, after forming the color layers 32. The columnar spacers may be replaced by spherical spacers arranged by dispersion or printing technique. The arrangement of the spherical spacers after the particle beam irradiation may reduce the obstacle due to the presence of the spacers during the particle beam irradiation.

In the present embodiment, although a color LCD panel is exemplified, the LCD panel may be a monochrome LCD panel. In manufacture of the monochrome LCD panel, the overcoat 33 is formed directly on the black matrix layer due to the absence of the color layers. The absence of the color layers 32 reduces irregularities of the surface of the overcoat 33, and reduces the interaction between the pigments and the drive electrodes, thereby suppressing the occurrence of the afterimage.

LCD panels were manufactured in accordance with the process of the present embodiment as a first sample, or first sample group, of the LCD panel of the present embodiment. For a comparison purpose, other LCD panels were also manufactured as first through third comparative examples, or comparative example groups. The first comparative example was such that both the first alignment film 23 of the active-matrix substrate 12 and the second alignment film 35 of the counter substrate 13 were manufactured using a rubbing technique, the second comparative example was such that the first alignment film 23 was formed using a particle irradiation technique and the second alignment film 35 was manufactured using a rubbing technique, and the third comparative example was such that both the first and second alignment films 23, 35 were manufactured using a particle irradiation technique.

First comparative tests were conducted by measurement of the pretilt angle, optical measurement, afterimage test, and long-term reliability test for all of the first sample and first through third comparative examples. The measurement of the pre-tile angle was conducted before bonding the polarizing films onto the LCD panel.

In advance of the first comparative tests, the surface of the first and second alignment films 23 and 35 of the first sample was observed using an AFM (Atomic Force Microscope). The observation revealed that the first alignment film 23 of the active-matrix substrate 12 had elongate grooves extending in the direction of the rubbing treatment, whereas the second alignment film 35 of the counter substrate 13 did not have such grooves.

The measurement of the pretilt angle was performed at a specific location on the front surface of the LCD panel. The measurement was performed to the first sample and first through third comparative examples in number of five LCD panels each group, and five points were measured for each LCD panel. The measured values were averaged for each of the first sample and first through third comparative examples. The measurement used a LC-characteristic evaluation equipment “OMS” supplied from Chuo Seiki co. The pretilt angle obtained as the average of the LCD panels of the first sample was 1.1 degrees, and the pretilt angle obtained as the average of the LCD panels of the first through third comparative examples was 0.5 degrees, 1.3 degrees and 2.0 degrees, respectively. More specifically, the first sample had an average pretilt angle of 1.1 degrees, which is only slightly higher than the average pretilt angle of the LCD panels of the first comparative example, and significantly lower than the average pretilt angle of the LCD panels of the second and third comparative example group.

The optical measurement was such that the LCD panels of the first sample and first through third comparative examples were assembled to LCD devices, and subjected to a visual observation of the appearance and measurement of the contrast ratio. The results of the tests are tabulated in Table 1, wherein active-matrix substrate is abbreviated as “AM”. “Roughly G” means slightly inferior to “Good” without a substantial problem, and NG means a failure in the characteristic.

TABLE 1

| | | | | Comp. | Comp. |
|---|---|---|---|---|---|
| | | Comp. Ex. 1 | Sample 1 | Ex. 2 | Ex. 3 |
| Alignment | AM | Rubbing | Rubbing | Particle | Particle |
| Film | Substrate | | | Irradiation | Irradiation |
| | Counter | Rubbing | Particle | Rubbing | Particle |
| | Substrate | | Irradiation | | Irradiation |

| | | | | |
|---|---|---|---|---|
| Visual Check | Roughly G | Good | Good | Good |
| Contrast Ratio | 1.00 | 1.10 | 1.04 | 1.01 |

In visual observation of the appearance, the front surface of the LCD device was observed visually, wherein existence of a line pattern, a luminescent spot, and unevenness was examined. The results shown in Table 1 reveal that the first comparative example exhibited a slight defect in the presence of a line pattern, whereas the first sample and second and third comparative examples did not exhibit such a line pattern. Before the visual test, a LCD panel including a failed TFT was excluded from the subsequent visual test. There was no electric damage in all the sample and comparative examples caused by an electrostatic breakdown due to the rubbing treatment.

Upon measuring the contrast ratio, the luminance of the brightest gray-scale level and darkest gray-scale level was measured at each measurement point, and the ratio of the average luminance of the brightest gray-scale level to the average luminance of the darkest gray-scale level is calculated to obtain the measured contrast ratio for each of the first sample and comparative examples. The measured contrast ratio was then normalized by the luminance measured for the first comparative example, and tabulated in Table 1.

As shown in Table 1, although the LCD panels of the second and third comparative examples exhibited only a 4% improvement and a 1% improvement, respectively, over the first comparative example, the LCD panels of the first sample exhibited a 10% improvement over the first comparative example.

Before the afterimage test, each LCD panel is assembled to a LCD device. In each LCD device, a checkered pattern including the brightest gray-scale level and the darkest gray-scale level that alternate one another in row and column directions is displayed on the screen for eight hours. Thereafter, a 128/256 gray-scale level was displayed on the entire screen for five minutes, and the presence or absence of afterimage was examined in a darkroom. The test was conducted at a room temperature, and the backlight was held ON at any time.

The visual observation of afterimage was evaluated in five steps of 0-4 of the level of the afterimage. A level of zero corresponds to no afterimage observed by the observer, and a single step corresponds to 1/256 of the gray-scale level, whereby a level of four corresponds to 3/256 added to the zero level. It is noted here that the practically allowable level corresponds to a level zero or level 1. Additionally, another gray-scale level of 57/256 was also employed for display on the entire screen instead of displaying the 128/256 gray-scale level. The results of the occurrence of the afterimage are shown in Table 2 for the display of both the 128/256 and 57/256 gray-scale levels. This test was executed for three LCD devices for each of the sample and comparative examples, and the results of three LCD devices were averaged.

TABLE 2

| | | Comp. | | Comp. | Comp. |
|---|---|---|---|---|---|
| | | Ex. 1 | Sample 1 | Ex. 2 | Ex. 3 |
| Alignment | AM | Rubbing | Rubbing | Particle | Particle |
| Film | Substrate | | | Irradiation | Irradiation |
| | Counter | Rubbing | Particle | Rubbing | Particle |
| | Substrate | | Irradiation | | Irradiation |
| Afterimage | 128/256 | 0 | 0 | 1 | 3 |
| | 57/256 | 0 | 1 | 2 | 4 |

As shown in Table 2, the LCD panels of the sample and first comparative example exhibited a practically allowable level, whereas the LCD panels of the second and third comparative examples did not. More specifically, the second comparative example incurred an intolerable afterimage of level 2 for the case of the 57/256 gray-scale level, and the third comparative example incurred an intolerable afterimage for the case of both the 128/256 and 57/256 gray-scale levels.

It is to be noted that in any of the sample and comparative examples, an afterimage was observed such that the luminance of the portion having displayed the bright level was observed to have a higher gray-scale level than the other portion after the switching from the checkered pattern. In addition, there was no significant range of variation in the level of the afterimage in each of these sample and comparative examples. In the above Table 2, the afterimage is more noticeable in the lower gray-scale level of 57/128. This is because the lower gray-scale level after the switching uses a smaller rotation, and thus a long-time fixed electric field of the brightest gray-scale level before the switching drove the LC molecules in a larger amount from the initial rotation after the switching.

The long-term reliability test was such that each LCD panel of the sample and comparative examples was assembled to a LCD device, which was then received in a constant temperature/humidity chamber set at a temperature of 60 degrees C and a humidity of 90%, was operated to display of the brightest gray-scale level on the entire screen, and was maintained for 500 hours in this state.

Before receiving each LCD device in the constant temperature/humidity chamber and after removing the each LCD device from the chamber to leave the each LCD device at a room temperature for a specific time length, a luminance meter was used to measure the luminance of the LCD device upon display of the darkest state, thereby obtaining the change (increase) of the luminance caused by the long-term reliability test. The “room temperature” as used herein means 20-25 degrees C. Upon removal of the each LCD device from the chamber, visual appearance test was also executed to examine presence or absence of the range of variation in the display. The results of the long-term reliability test are shown in table 3.

TABLE 3

| | | Comp. | | Comp. | |
|---|---|---|---|---|---|
| | | Ex. 1 | Sample 1 | Ex. 2 | Comp. Ex. 3 |
| Alignment | AM | Rubbing | Rubbing | Particle | Particle |
| Film | Substrate | | | Irradiation | Irradiation |
| | Counter | Rubbing | Particle | Rubbing | Particle |
| | Substrate | | Irradiation | | Irradiation |

| | | | | |
|---|---|---|---|---|
| Visual Check | Roughly | Good | Roughly | Good |
| | G | | G | |
| Increase of Luminance | 1.01 | 1.02 | 1.06 | 1.10 |

As shown in Table 3, the visual check of the appearance was substantially of no problem without revealing a significant range of variation on the screen; however, the first and second comparative examples exhibited a small bright spot on the portion that has displayed the darkest gray-scale level and the vicinity thereof that has displayed a higher gray-scale level. The sample and third comparative example did not exhibit any such a bright spot. It is concluded here that the bright spot occurred because the dust was generated during the rubbing treatment, stayed on the columnar spacers of the counter substrate and caused a failed alignment of the LC molecules in the vicinity of the dust after the operation in the long-term reliability test.

As to the change of luminance caused by the long-time reliability, the increase in the luminance was small in the sample and first comparative example, which exhibited 2% and 1% increase, respectively. On the other hand, the second and third comparative examples exhibited a significant increase in the luminance such as 6% and 10% increase, respectively. This may cause an obstacle against the image quality after a long-term operation of the LCD device.

In the optical test of the above first comparison tests, it may be concluded that the sample had a higher image quality compared to the first comparative example in which both the alignment films are formed by the rubbing treatment. In the afterimage test, the sample had a slightly higher degree of afterimage compared to the first comparative example; however, had an improved level for the afterimage compared to the second comparative example wherein the alignment films of the active-matrix substrate and the counter substrate were formed by particle beam irradiation and rubbing treatment and the third comparative example wherein both the alignment films were formed by particle beam irradiation. The long-term reliability test revealed that the sample exhibited a higher long-term reliability wherein the afterimage level and image quality can be maintained at the superior state for a long period of time.

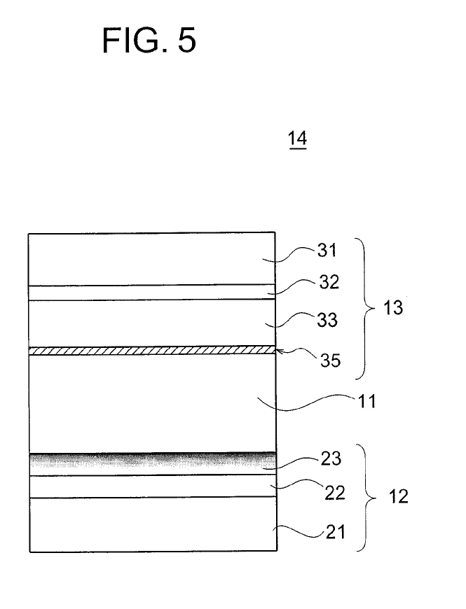

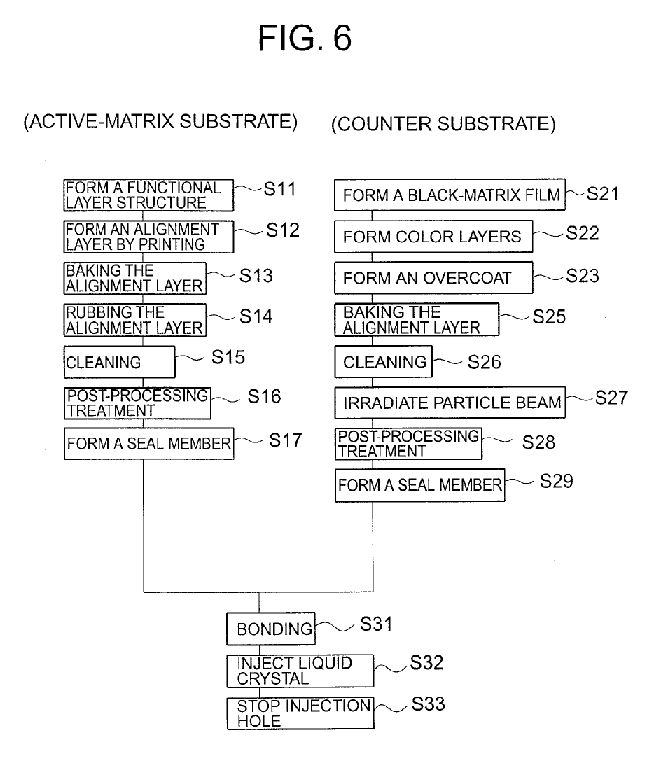

FIG. 5 is a sectional view showing the schematic structure of a LCD panel according to a second embodiment of the present invention. The LCD panel, generally designated by numeral 14, has a structure similar to the structure of the LCD panel 10 of FIG. 1 except that the alignment layer in the counter substrate 13 is formed integrally with the overcoat 33 in the present embodiment. FIG. 6 is a flowchart showing the procedure of a process for manufacturing the LCD panel 14 of FIG. 5. The procedure of FIG. 6 is similar to the procedure of FIG. 2 except that the step S24 in FIG. 2 for forming the alignment layer is omitted in FIG. 6.

The step S23 in FIG. 6 for forming the overcoat 33 is such that a copolymer having a bridging radical and made of an acrylic resin and a monomer containing an aromatic ring is dissolved in an organic solvent and spin-coated on the underlying layer. The polymeric resin film configuring the overcoat 33, although not limited to the above material, may preferably include a suitable number of π-conjugate double bonds between carbon atoms and other atoms in order for effective alignment force for the LC molecules. The bridging radical may be omitted, and in such a case, polymeric molecules may preferably have a higher degree of polymerization or have a branch structure, in order for suppressing the anisotropy of the alignment film.

During the baking step S25, the counter substrate 13 is mounted on a hot plate (not shown), heated by a heat treatment using a two-step increase of the temperature up to 80 degrees C and 120 degrees C in a low-concentration oxygen environment, thereby removing the solvent in the overcoat 33. Subsequently, as shown in FIG. 4C, the counter substrate 13 is introduced in the baking furnace 41, wherein a baking treatment in a nitrogen atmosphere is performed to harden the overcoat 33. The baking treatment is conducted at a substrate temperature of 200 degrees C for an hour, for example. After cooling the counter substrate 13, columnar spacers are formed on the overcoat 33.

During the particle beam irradiation, the particle beam is irradiated onto the surface of the overcoat 33, similarly to the first embodiment, to thereby form the second alignment film 35. The post-processing treatment of Step S28 is also similar to the first embodiment.

In the present embodiment, the step S24 for forming the alignment layer 34 is omitted to simplify the procedure of the process, thereby improving the through-put of the products.

LCD panels were manufactured according to the present embodiment to obtain a second sample or second sample group. For a comparison purpose, LCD panels of a fourth comparative example were also manufactured wherein the overcoat 33 of the counter substrate 13 was subjected to an alignment treatment using a rubbing technique to form the second alignment film 35.

As second comparison tests, the LCD panels of the second sample and the fourth comparative example were subjected to optical measurement test, afterimage test, and a long-term reliability test. The results of the second comparison tests are shown in Table 4, wherein the results of the first sample and first comparative example are again shown for a reference purpose.

TABLE 4

| | | 1st Sample | 2nd Sample | Comp. Ex. 1 | Comp. Ex. 4 |
|---|---|---|---|---|---|
| Alignment Film | | Alignment | Overcoat | Alignment | Overcoat |
| (Counter Sub.) | | layer/Overcoat | | layer/Overcoat | |
| Alignment treatment | | Particle beam | Particle beam | Rubbing | Rubbing |
| Visual test | | Good | Good | Roughly G | NG |
| Contrast ratio | | 1.10 | 1.08 | 1.00 | 0.90 |
| Afterimage | 128/256 | 0 | 0 | 0 | 2 |
| | 57/256 | 1 | 1 | 0 | 3 |

| | | | | | |
|---|---|---|---|---|---|
| Reliability | Appearance | Good | Good | Roughly G | NG |
| test | Luminance | 1.02 | 1.02 | 1.01 | 1.10 |

As shown in Table 4, the LCD panel of the second sample exhibited a superior result in the visual test similarly to the first sample. On the other hand, the fourth comparative example exhibited a poor result, wherein a stripe pattern was observed in a higher degree compared to the first comparative example. The contrast ratio of the second sample was slightly lower than the first sample; however, increased in an amount of 8% compared to the first comparative example. The fourth comparative example exhibited a 10% reduction in he contrast ratio compared to the first comparative example.

As to the afterimage level in the second comparative tests, the second sample exhibited a practically allowable level of the afterimage, similarly to the first sample. On the other hand, the fourth comparative example exhibited a noticeable afterimage and was judged to have a practically intolerable level of the afterimage.

As to the long-term reliability, the second sample did not show an increase in the luminance upon display of a darkest gray-scale level or a significant range of variation after the operation in the constant temperature/humidity chamber. The fourth comparative example exhibited a significant increase in the luminance and a significant rang of variation, whereby the fourth comparative example is judged not suitable for the practical use.

Based on the results of the second comparative tests, it was judged that the LCD panel of the second sample had a superior image quality, suitable level of the afterimage and a suitable long-term reliability, as in the case of the first sample. It was also concluded based on the test results of the fourth comparative example that the rubbing treatment of the overcoat does not provide a suitable alignment film achieving a suitable image quality or a suitable level of the afterimage.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined in the claims.

What is claimed is:

1. A liquid crystal display (LCD) panel comprising: a liquid crystal (LC) layer; an active-matrix substrate including an electrode layer for applying a lateral electric field to said LC layer, and a counter substrate opposing said active-matrix substrate with an intervention of said LC layer,
said active-matrix substrate including a first alignment film in contact with said LC layer, said first alignment film being formed using a rubbing process,
said counter substrate including a second alignment film in contact with said LC layer, said second alignment film being formed using a lo non-contact alignment process.

2. The LCD panel according to claim 1, wherein said second alignment film is formed on a surface portion of an overcoat overlying said counter substrate.

3. The LCD panel according to claim 2, wherein said second alignment film includes a conjugate double bond.

4. The LCD panel according to claim 1, wherein said second alignment film includes a polymeric molecule.

5. The LCD panel according to claim 4, wherein said second alignment film is formed by a particle beam irradiation process.

6. A liquid crystal display (LCD) panel comprising: a liquid crystal (LC) layer; an active-matrix substrate including an electrode layer for applying a lateral electric field to said LC layer, and a counter substrate opposing said active-matrix substrate with an intervention of said LC layer,
said active-matrix substrate including a first alignment film having a first surface in contact with said LC layer, said first surface including thereon a plurality of grooves extending parallel to one another for aligning said LC layer,
said counter substrate including a second alignment film having a lo second surface in contact with said LC layer, said second surface including thereon no groove.

7. The LCD panel according to claim 6, wherein said second alignment film is formed on a surface portion of an overcoat overlying said counter substrate.

8. The LCD panel according to claim 7, wherein said second alignment film includes a conjugate double bond.

9. The LCD panel according to claim 6, wherein said second alignment film includes a polymeric molecule.

10. The LCD panel according to claim 9, wherein said second alignment film is formed by a particle beam irradiation process.

11. A method for manufacturing a liquid crystal display panel comprising: a liquid crystal (LC) layer; an active-matrix substrate including an electrode layer for applying a lateral electric field to said LC layer, and a counter substrate opposing said active-matrix substrate with an intervention of said LC layer, said method comprising:
forming a first alignment layer on said active-matrix substrate;
rubbing said first alignment layer to form a first alignment film;
forming a second alignment layer on said counter substrate; and
irradiating at least one of a light beam and a particle beam onto said second alignment layer to form a second alignment film.
